(19) United States
(12) Patent Application Publication
(10) Pub. No.: US 2017/0033483 A1
(43) Pub. Date: Feb. 2, 2017

(54) Connection Terminal and Terminal Assembly

(71) Applicant: Tyco Electronics (Shanghai) Co. Ltd., Shanghai (CN)

(72) Inventors: Wang ZHENGXI, Shanghai (CN); Zhou ZHAOWEN, Shanghai (CN)

(21) Appl. No.: 15/222,869

(22) Filed: Jul. 28, 2016

(30) Foreign Application Priority Data
Jul. 29, 2015 (CN) 201510456151.2

(51) Int. Cl. H01R 12/75; H01R 24/20

(52) U.S. Cl. CPC H01R 12/75; H01R 24/20; H01R 2101/00

(57) ABSTRACT

The present invention discloses a connection terminal and a terminal assembly. The connection terminal comprises a first connecting portion. The first connecting portion includes a corrugation. A corrugation extending direction of the corrugation is not perpendicular to an insertion direction of the first connecting portion of the connection terminal. The terminal assembly includes a mating electrically-connecting member and further includes the connection terminal. The mating electrically-connecting member has a mating end for receiving the first connecting portion of the connection terminal. According to the connection terminal and the terminal assembly of the present invention, material costs are reduced by disposing the corrugation on the connection terminal, and the advantages that a connection is firm and an operation is easy are achieved.

### RELATED APPLICATIONS

The present application claims priority to CN201510456151.2, filed Jul. 29, 2015, the entire disclosure of which being hereby expressly incorporated herein by reference.

### TECHNICAL FILED

The present invention relates generally to a connection terminal and a terminal assembly.

### BACKGROUND

A connection terminal is generally connected to a lead wire via a lead wire connection member which has a receiving slot for receiving the connection terminal. The receiving slot generally has a standard size. A connection part of the connecting terminal matching the standard receiving slot needs to be configured to correspond to the size of the standard receiving slot. For example, a thickness of the connection terminal corresponds to a height of the standard receiving slot. In some cases, the connection terminal needs to be thinned. Although a size requirement of the standard receiving slot may be met by folding a connection part of a thin connection terminal or by stacking multiple thin connection terminals, these methods are far from economical.

### SUMMARY OF THE INVENTION

An objective of the present invention is to provide a connection terminal and a terminal assembly, so as to eliminate one or more defects in the prior art.

According to a first aspect of the present invention, a connection terminal is provided. The connection terminal comprises a first connecting portion which comprises a corrugation, and a corrugation extending direction of the corrugation is not perpendicular to an insertion direction of the first connecting portion of the connection terminal.

Preferably, the corrugation extending direction is the same as the insertion direction of the first connecting portion. More preferably, the corrugation extending direction is parallel with the insertion direction of the first connecting portion.

Preferably, the first connecting portion further comprises a body. The corrugation comprises a ridge and a valley. A vertical distance between the ridge and the valley is an integer multiple of a thickness of the body of the first connecting portion. More preferably, the vertical distance between the ridge and the valley is twice the thickness of the body of the first connecting portion.

Preferably, the first connecting portion further comprises a body. The corrugation comprises a ridge and a valley, each of which protrudes from a surface of the body.

Preferably, the corrugation comprises a ridge. The ridge continuously extends perpendicular to the insertion direction of the first connecting portion to edges of the first connecting portion.

Preferably, the connection terminal further comprises a second connecting portion which has insertion-connection pins used to form an insertion-connection with an electrical device. More preferably, the insertion-connection pins are disposed to form an insertion-connection with a printed circuit board (PCB).

Preferably, the connection terminal further comprises a second connecting portion which has curved arms used to be press-connected to a lead wire.

Preferably, the corrugation is made by using a stamping process.

Preferably, the first connecting portion comprises multiple corrugations. More preferably, the multiple corrugations are in the shape of a sine wave.

According to a second aspect of the present invention, a terminal assembly is provided. The terminal assembly comprises a mating electrically-connecting member and the foregoing connection terminal, and wherein the mating electrically-connecting member has a mating end for receiving the first connecting portion of the connection terminal.

Preferably, the mating end of the mating electrically-connecting member comprises a bottom wall and a pair of bent arms that extend upward and opposite to each other from edges on two sides of the bottom wall, and the bottom wall and the pair of bent arms define a receiving slot; and after the first connecting portion is inserted into the receiving slot, the corrugation abuts against ends of the pair of bent arms and the bottom wall. More preferably, the first connecting portion comprises multiple corrugations. The first connecting portion is in multi-point contact with the ends of the bent arms via the multiple corrugations.

Preferably, the mating electrically-connecting member further comprises a lead wire fixing portion used to be fixedly connected to a lead wire.

According to the connection terminal and the terminal assembly of the present invention, material costs are reduced by disposing a corrugation on the connection terminal, and the advantages that a connection is firm and an operation is easy are achieved.

### BRIEF DESCRIPTION OF DRAWINGS

FIG. 1 is a schematic perspective view of a connection terminal according to an embodiment of the present invention;

FIG. 2 is a schematic cross-sectional view of the connection terminal of FIG. 1;

FIG. 3 is a schematic perspective view of a mating electrically-connecting member according to an embodiment of the present invention;

FIG. 4 is a schematic front view of the mating electrically-connecting member shown in FIG. 3;

FIG. 5 is a schematic perspective view of a terminal assembly assembled by the connection terminal shown in FIG. 1 and the mating electrically-connecting member shown in FIG. 3; and

FIG. 6 is a schematic cross-sectional view of the terminal assembly of FIG. 5.

### DETAILED DESCRIPTION OF EMBODIMENTS

A connection terminal and a terminal assembly of the present invention are described in detail in the following with reference to the accompanying drawings. Persons skilled in the art should understand that the embodiments described in the following are merely exemplary descriptions of the present invention, but are not intended to limit the present invention. In all the accompanying drawings, identical reference numerals denote identical or similar components.

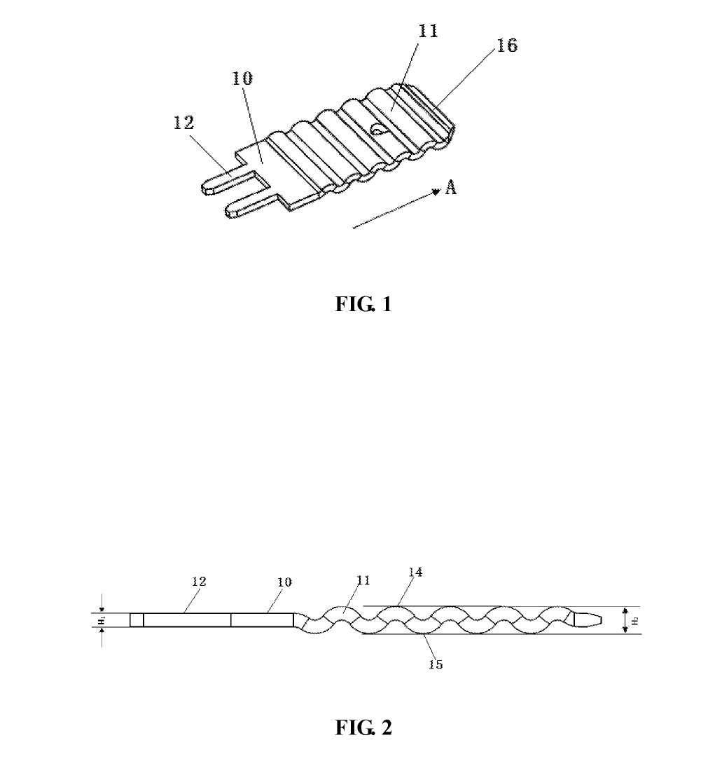

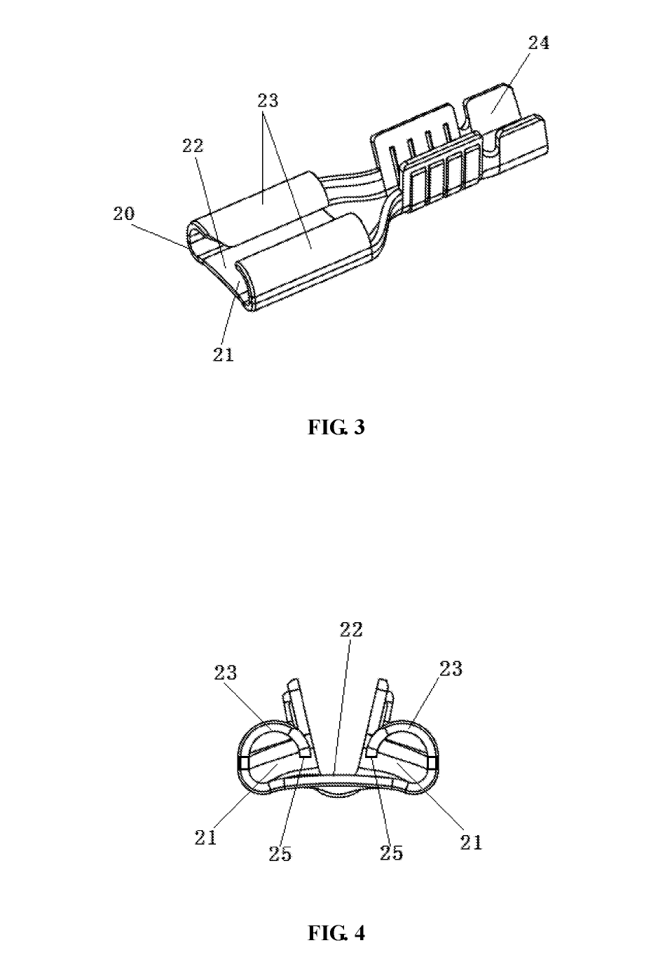

Referring FIG. 1 to FIG. 6, a connection terminal according to the present invention comprises a first connecting portion 16 and a second connecting portion 12. The first connecting portion 16 is used to be connected to a mating electrically-connecting member. The second connecting portion 12 is used to be connected to an electrical device (for example, a power supply, a circuit board, or the like) or a lead wire. The mating electrically-connecting member has a mating end 20 which is used to mate with and be connected to the first connecting portion 16 of the connection terminal. An insertion direction of the first connecting portion 16 of the connection terminal inserted into the mating end 20 of the mating electrically-connecting member is indicated by an arrow A in FIG. 1. In an embodiment shown by the accompanying drawings, the first connecting portion 16 has a body 10 and a corrugation or a corrugation portion 11. In another embodiment, the section of the corrugation or corrugation portion 11 may occupy the entire first connecting portion 16.

In a specific embodiment, the mating end 20 of the mating electrically-connecting member has a bottom wall 22 and a pair of bent arms 23 that extend upward and opposite to each other from edges on two sides of the bottom wall 22, and the bottom wall 22 and the pair of bent arms 23 define a receiving slot 21. The receiving slot 21 is used to receive the first connecting portion 16, and ends 25 of the bent arms 23 are used to clamp and fix the first connecting portion 16. A size of the mating electrically-connecting member is generally a standard value, and for example, a vertical distance between the ends 25 of the bent arms 23 and the bottom wall 22 is a standard value, thus requiring that the first connecting portion 16 of the connection terminal forming an insertion-connection with the mating electrically-connecting member should have a corresponding standard thickness. On the premise that the connecting terminal meets the requirements of electrical performance, decreasing the thickness of the connection terminal can reduce material costs, but a non-adaptive clamping problem occurs when a connection terminal with a thickness thinner than an original standard thickness is connected to an original standard mating electrically-connecting member. In order to solve the problem, the inventor of the present invention disposes the corrugation 11 on the first connecting portion 16 of the connection terminal, so as to effectively increase a spatial thickness of the first connecting portion 16. Referring to FIG. 2, after the corrugation 11 is disposed, the resulting spatial thickness H₂ is significantly greater than the thickness H₁ of the body 10 of the first connecting portion 16, and the spatial thickness H₂ can meet the connecting requirement of the original standard mating electrically-connecting member.

In the present invention, a corrugation extending direction of the corrugation 11 (i.e., a direction of wave propagation) is arranged to be not perpendicular to the insertion direction A along which the first connecting portion 16 is inserted into the receiving slot 21. In a preferred embodiment, the corrugation extending direction of the corrugation 11 is the same as the insertion direction A along which the first connecting portion 16 is inserted into the receiving slot 21, that is, the corrugation extending direction and the insertion direction A are substantially along the same direction. In a more preferred embodiment, the corrugation extending direction of the corrugation 11 is parallel with the insertion direction A along which the first connecting portion 16 is inserted into the receiving slot 21. The foregoing arranged manner enables that when the connection terminal is connected to the mating electrically-connecting member, the clamping position is fixed, the operation is easy, and an electrical connection is firm. The corrugation 11 may be made by using a simple stamping process, and multiple connection terminals having the corrugation 11 may be stacked tightly to facilitate storage and save space during transportation. However, if the corrugation extending direction of the corrugation 11 is arranged to be perpendicular to the insertion direction A along which the first connecting portion 16 is inserted into the receiving slot 21, it cannot be ensured that the ends 25 of the pair of bent arms 23 of the mating electrically-connecting member clamp the top of the corrugation 11 when connected each time.

The corrugation 11 comprises a ridge 14 which continuously extends perpendicular to the insertion direction A of the first connecting portion 16 (i.e., in a width direction) to edges of the first connecting portion 16, so that when the connection terminal is docked with the receiving slot 21 of the mating electrically-connecting member, the ends 25 of the bent arms 23 of the receiving slot 21 can always be in contact with the ridge 14.

In some embodiments, there are multiple continuous corrugations 11, each of which has a ridge 14 and a valley 15, and the ridge 14 and the valley 15 each protrude from a surface of the body 10. In a preferred embodiment, the multiple corrugations 11 are in the shape of a sine wave, so that the respective apexes of the ridges 14 are located on the same straight line and the respective lowest points of the valleys 15 are also located on the same straight line, and therefore, when the connection terminal is connected to the mating electrically-connecting member, the ridges 14 of the corrugations 11 abut against the ends 25 of the pair of bent arms 23 at multiple points and the valleys 15 of the corrugations 11 abuts against on the bottom wall 22 at multiple points. This connection manner can effectively improve effectiveness and stability of the electrical connection. In some embodiments, the spatial thickness H₂ (i.e., the vertical distance between the ridge 14 and the valley 15) formed by the corrugation 11 is an integer multiple of the thickness H₁ of the body 10 of the first connecting portion 16. In a specific embodiment, the spatial thickness H₂ formed by the corrugation 11 is twice the thickness H₁ of the body 10 of the first connecting portion 16, so that the material costs can be reduced by 50%.

The second connecting portion 12 of the connection terminal used to be connected to an electrical device or a lead wire may be disposed to be parallel with or form an angle with (for example, be perpendicular to) the insertion direction A of the first connecting portion 16. In the embodiment shown in FIG. 1, the second connecting portion 12 has insertion-connection pins used to form an insertion-connection with an electrical device, for example, forming an insertion-connection with a printed circuit board (PCB), and the extending direction of the insertion-connection pins is parallel with the corrugation extending direction of the first connecting portion 16. In another embodiment, the second connecting portion 12 has curved arms used to be press-connected to a lead wire.

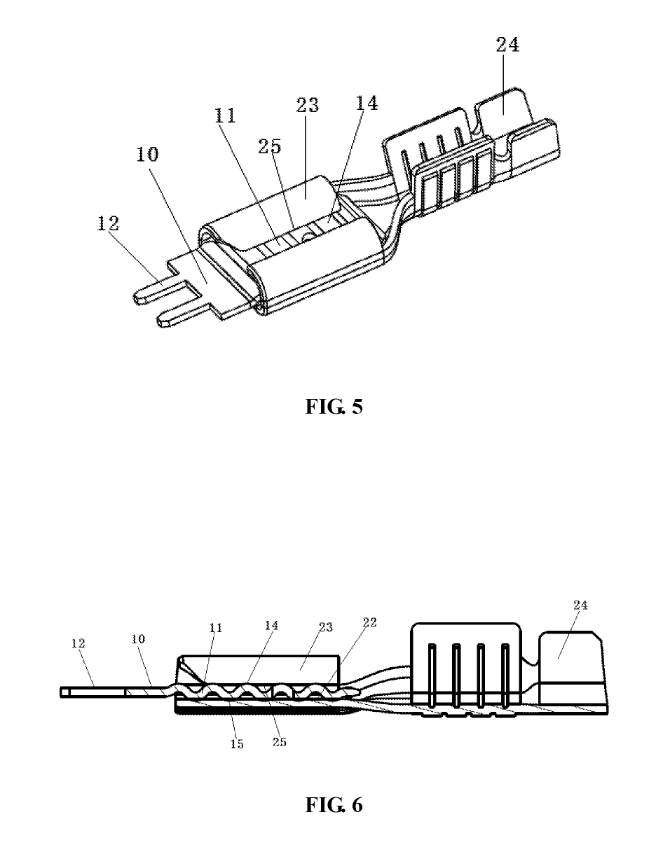

Referring to FIG. 5 and FIG. 6, the connection terminal and the mating electrically-connecting member in the present invention are assembled to form a terminal assembly used to transmit an electrical signal. During assembly, firstly, the first connecting portion 16 of the connection terminal is inserted into the receiving slot 21 of the mating electrically-connecting member, and then, a pressure is applied to the pair of bent arms 23 of the mating electrically-connecting member, so that the ridge 14 of the corrugation 11 abuts against the ends 25 of the pair of bent arms 23 and the valley 15 of the corrugation 11 abuts against the bottom wall 22, and therefore, the first connecting portion 16 of the connection terminal is clamped and fixed in the receiving slot 21 of the mating electrically-connecting member. In the shown embodiment, the mating electrically-connecting member is a lead wire connection member, and a connection end 24 of the mating electrically-connecting member is a lead wire fixing portion which may have curved arms used to be press-connected to a lead wire. In another embodiment, the mating electrically-connecting member also may be other electrical component.

The specific shape, direction, and structure of the connection terminal and the terminal assembly described in the foregoing or shown in the drawings are merely exemplary and the ordinary persons skilled in the art can make various modifications to them under the teaching of the present invention, and all the modifications do not depart from the scope of the present invention defined by the claims.

1. A connection terminal comprising a first connecting portion, wherein the first connecting portion comprises a corrugation portion, which has a corrugation extending direction extending in a direction not perpendicular to an insertion direction of the first connecting portion of the connection terminal.

2. The connection terminal according to claim 1, wherein the corrugation extending direction is the same as the insertion direction of the first connecting portion.

3. The connection terminal according to claim 2, wherein the corrugation extending direction is parallel with the insertion direction of the first connecting portion.

4. The connection terminal according to claim 1, wherein the first connecting portion further comprises a body; the corrugation portion comprises a ridge and a valley; and a vertical distance between the ridge and the valley is an integer multiple of a thickness of the body of the first connecting portion.

5. The connection terminal according to claim 4, wherein the vertical distance between the ridge and the valley is twice the thickness of the body of the first connecting portion.

6. The connection terminal according to claim 1, wherein the first connecting portion further comprises a body; wherein the corrugation portion comprises a ridge and a valley; and wherein the ridge and the valley each protrude from a surface of the body.

7. The connection terminal according to claim 1, wherein the corrugation portion comprises a ridge which continuously extends perpendicular to the insertion direction of the first connecting portion to edges of the first connecting portion.

8. The connection terminal according to claim 1, further comprising a second connecting portion, wherein the second connecting portion has insertion-connection pins used to form an insertion-connection with an electrical device.

9. The connection terminal according to claim 8, wherein the insertion-connection pins are disposed to form an insertion-connection with a printed circuit board.

10. The connection terminal according to claim 1, wherein the connection terminal further comprises a second connecting portion, wherein the second connecting portion has curved arms used to be press-connected to a lead wire.

11. The connection terminal according to claim 1, wherein the corrugation portion is a stamping corrugation.

12. The connection terminal according to claim 1, wherein the first connecting portion comprises multiple corrugations.

13. The connection terminal according to claim 12, wherein the multiple corrugations are in the shape of a sine wave.

14. A terminal assembly comprises a mating electrically-connecting member and the connection terminal according to claim 1, wherein the mating electrically-connecting member has a mating end for receiving the first connecting portion of the connection terminal.

15. The terminal assembly according to claim 14, wherein the mating end of the mating electrically-connecting member comprises a bottom wall and a pair of bent arms that extend upward and opposite to each other from edges on two sides of the bottom wall; wherein the bottom wall and the pair of bent arms define a receiving slot; and wherein the corrugation abuts against ends of the pair of bent arms and the bottom wall, after the first connecting portion is inserted into the receiving slot.

16. The terminal assembly according to claim 15, wherein the first connecting portion comprises multiple corrugation portions; and wherein the first connecting portion is in multi-point contact with the ends of the bent arms via the multiple corrugation portions.

17. The terminal assembly according to claim 14, wherein the mating electrically-connecting member further comprises a lead wire fixing portion for fixedly connecting to a lead wire.
